(19) United States
(12) Patent Application Publication
(10) Pub. No.: US 2025/0242612 A1
(43) Pub. Date: Jul. 31, 2025

(54) TAPE PRINTER AND CONTROL METHOD FOR TAPE PRINTER

(71) Applicant: SEIKO EPSON CORPORATION, Tokyo (JP)

(72) Inventor: Kenji MOTAI, Matsumoto-shi (JP)

(73) Assignee: SEIKO EPSON CORPORATION, Tokyo (JP)

(21) Appl. No.: 19/037,743

(22) Filed: Jan. 27, 2025

(30) Foreign Application Priority Data
Jan. 26, 2024 (JP) 2024-009988

(51) Int. Cl. B41J 11/42; B41J 2/325; B41J 3/407; B41J 11/00; B41J 11/04; B41J 11/70; B41J 15/04; B41J 29/38

(52) U.S. Cl. CPC B41J 11/425; B41J 2/325; B41J 3/4075; B41J 11/0095; B41J 11/04; B41J 11/703; B41J 15/044; B41J 29/38

(57) ABSTRACT

A tape printer. With a position of tape being in a detection position of a sensor, the printer causes a drive motor to rotate in one direction of a first rotation direction and a second rotation direction by a first rotation amount and then causes the drive motor to rotate in a reverse direction. The printer measures a detected rotation amount that is the amount of rotation of the drive motor from when the drive motor starts rotating in the reverse direction to when the passage of the specific position of the tape through the detection position is detected. The tape printer calculates an idle feed amount based on the measured detected rotation amount and the first rotation amount. The idle feed amount is the amount of rotation of the drive motor from the reversal of rotation of the drive motor until the start of rotation of a platen roller.

The present application is based on, and claims priority from JP Application Serial Number 2024-009988, filed Jan. 26, 2024, the disclosure of which is hereby incorporated by reference herein in its entirety.

### BACKGROUND

### 1. Technical Field

The present disclosure relates to a tape printer and a control method for a tape printer.

### 2. Related Art

A printer disclosed in JP-A-2009-148926 is a known printer including a drive motor and a gear train mechanism configured to transmit power of the drive motor to a feed roller for feeding tape. In such a printer, when the direction of rotation of the drive motor is reversed, the accuracy with which the tape is fed may decrease due to backlash in the gear train mechanism. To address such a problem, the printer drives the drive motor to the extent that the backlash in the gear train mechanism is compensated after the reversal of rotation of the drive motor, and the printer then drives the drive motor to the extent that the tape is advanced by the tape feed amount. The amount by which the drive motor rotates after the reversal of rotation of the drive motor before the start of rotation of the feed roller is herein referred to as an idle feed amount.

The printer known in the art is designed on the premise that each printer has a fixed idle feed amount. In actuality, however, there are product-to-product variations in the idle feed amount. That is, the actual idle feed amount is not always exactly the same as the idle feed amount estimated at design time. Accordingly, there is a issue that even when the printer known in the art drives the drive motor by the fixed amount after the reversal of rotation of the drive motor and then drives the drive motor to the extent that the tape is advanced by the tape feed amount, the accuracy with which the tape is fed is not sufficient.

### SUMMARY

According to an aspect of the present disclosure, a tape printer includes a drive motor, a gear train mechanism, a sensor, and a control unit. The drive motor rotates in a first rotation direction and in a second rotation direction opposite to the first rotation direction. The gear train mechanism transmits power of the drive motor to a feed roller for feeding tape. The sensor detects a specific position of the tape. The control unit is configured to perform measurement control and calculation control. The measurement control is control in which, with the specific position of the tape being in a detection position of the sensor, the control unit is configured to cause the drive motor to rotate in one direction of the first rotation direction and the second rotation direction by a first rotation amount and then causes the drive motor to rotate in a reverse direction to the one direction. The control unit is configured to measure a detected rotation amount that is an amount of rotation of the drive motor from when the drive motor starts rotating in the reverse direction to when passage of the specific position of the tape through the detection position is detected. The calculation control is control in which the control unit is configured to calculate an idle feed amount based on the detected rotation amount measured in the measurement control and the first rotation amount. The idle feed amount is an amount of rotation of the drive motor from reversal of rotation of the drive motor until a start of rotation of the feed roller.

According to an aspect of the present disclosure, a control method for a tape printer including a drive motor, a gear train mechanism, and a sensor is provided. The drive motor rotates in a first rotation direction and in a second rotation direction opposite to the first rotation direction. The gear train mechanism transmits power of the drive motor to a feed roller for feeding tape. The sensor detects a specific position of the tape. The control method includes measuring a detected rotation amount and calculating an idle feed amount. With the specific position of the tape being in a detection position of the sensor, the tape printer causes the drive motor to rotate in one direction of the first rotation direction and the second rotation direction by a first rotation amount and then causes the drive motor to rotate in a reverse direction to the one direction. The detected rotation amount is an amount of rotation of the drive motor from when the drive motor starts rotating in the reverse direction to when passage of the specific position of the tape through the detection position is detected. The idle feed amount is calculated based on the detected rotation amount measured in the measuring and the first rotation amount. The idle feed amount is an amount of rotation of the drive motor from reversal of rotation of the drive motor until a start of rotation of the feed roller.

### BRIEF DESCRIPTION OF THE DRAWINGS

FIG. 1 is an external view of a tape printer and a tape cartridge.

FIG. 2 illustrates the placement of a print head, a sensor, and a cutter.

FIG. 3 illustrates an example of tape.

FIG. 4 is a block diagram illustrating the hardware configuration of the tape printer.

FIG. 5 illustrates an example of a gear train mechanism.

FIG. 6 is a flowchart of printing processing.

FIG. 7 is a continuation of the flowchart in FIG. 6.

FIG. 8 is a continuation of the flowchart in FIG. 6.

FIG. 9 is a continuation of the flowchart in FIG. 8.

FIG. 10 illustrates a state in which the leading edge of the tape is further in the −X direction than a detection position.

FIG. 11 illustrates a state in which the leading edge of the tape is in the detection position.

FIG. 12 illustrates the following state: with the leading edge of the tape being in the detection position, the drive motor is rotated in a second rotation direction by a first rotation amount.

FIG. 13 illustrates the following state: with a margin distance being shorter than a sensor-to-head distance, the tape is placed in a printing start position.

FIG. 14 illustrates the following state: with the margin distance being longer than the sensor-to-head distance, the tape is placed in the printing start position.

FIG. 15 illustrates a state in which the leading edge of the tape is further in the +X direction than the detection position.

FIG. 16 illustrates the following state: with the leading edge of the tape being in the detection position, the drive motor is rotated in a first rotation direction by the first rotation amount.

FIG. 17 is part of a flowchart in Variation 1.

FIG. 18 is a block diagram illustrating the hardware configuration of a tape printer in Variation 2.

FIG. 19 is a flowchart in Variation 2.

FIG. 20 is a continuation of the flowchart in FIG. 19.

### DESCRIPTION OF EMBODIMENTS

A tape printer and a control method for a tape printer are described below with reference to the accompanying drawings. Although some of the drawings are described below based on a Cartesian coordinate system defined by X-, Y-, and Z-axis, the following embodiment is in any way not limited by the directions of the axis, which are mentioned merely for convenience of illustration.

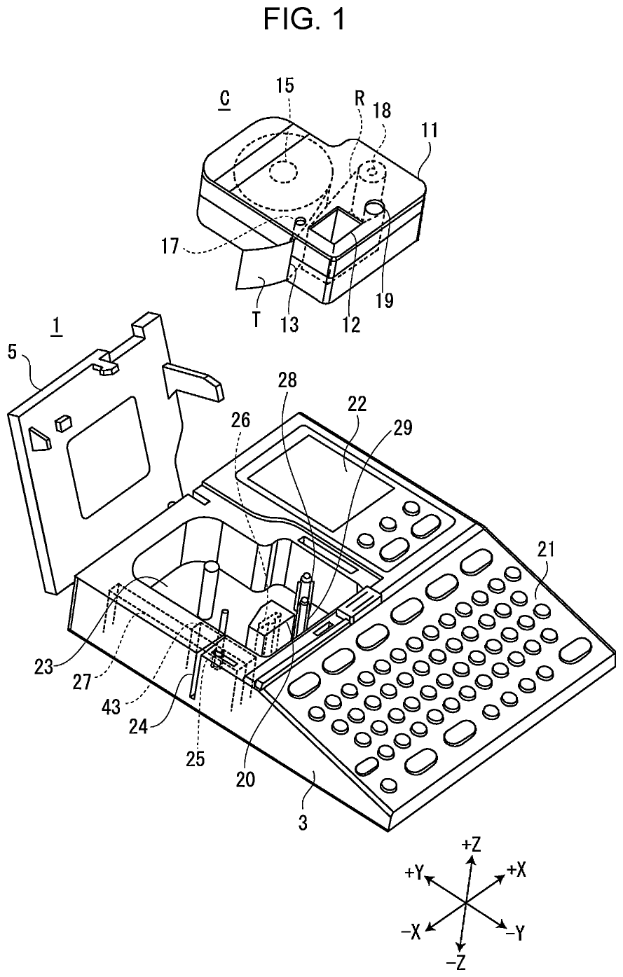

FIG. 1 is an external view of a tape printer 1 and a tape cartridge C. The tape printer 1 is a device that prints on long tape, which is denoted by T. The tape T for use with the tape printer 1 according to the present embodiment is a roll of print tape that is to be subjected to printing with release paper tape attached thereon.

The tape printer 1 includes a device case 3 and a mounting section cover 5. An operational key group 21, a display 22, a cartridge mounting section 23, and a tape outlet 24 are located on a surface on the +Z side of the device case 3.

The operational key group 21 accepts various operations performed by the user to edit an image that is to be printed on the tape T. Various kinds of information, such as a print image editing screen, is displayed on the display 22. The tape printer 1 produces print data based on the print image editing operations performed by the user and then executes printing processing based on the print data.

The cartridge mounting section 23 is a recess where the +Z side is open. The tape cartridge C is removably mounted in the cartridge mounting section 23. The mounting section cover 5 is rotatably attached to an end on the +Y side of the device case 3 to open and close the cartridge mounting section 23.

The tape cartridge C includes a tape core 15, a platen roller 17, an unreeling core 18, a take-up core 19, and a cartridge case 11. The tape core 15, the platen roller 17, the unreeling core 18, and the take-up core 19 are housed in the cartridge case 11. The platen roller 17 is an example of a feed roller.

The tape T is wound around the tape core 15. An ink ribbon R is wound around the unreeling core 18. The ink ribbon R on the unreeling core 18 is unreeled and is then taken up on the take-up core 19. The cartridge case 11 has a head insertion hole 12, which is a through-hole extending along the Z-axis. A face on the −X side of the cartridge case 11 has a tape output port 13, which extends along the Z-axis. The tape T on the tape core 15 is unreeled and then comes out of the cartridge case 11 through the tape output port 13.

A print head 26 and a head cover 20 are disposed in the cartridge mounting section 23. The print head 26 prints on the tape T. The print head 26 is partially covered with the head cover 20.

A platen drive shaft 25, an unreeling shaft 28, and a take-up shaft 29 protrude from the bottom face of the cartridge mounting section 23 and extend in the +Z direction. The platen drive shaft 25 is an example of a roller drive shaft. When the tape cartridge C is mounted in the cartridge mounting section 23, the platen drive shaft 25, the unreeling shaft 28, and the take-up shaft 29 fit in the platen roller 17, the unreeling core 18, and the take-up core 19, respectively.

The print head 26 and the head cover 20 are inserted into the head insertion hole 12 at the time when the tape cartridge C is mounted in the cartridge mounting section 23. Closing the mounting section cover 5 causes a head movement mechanism (not illustrated) to move the print head 26 toward the platen roller 17. As a result, the tape T and the ink ribbon R are held between the print head 26 and the platen roller 17.

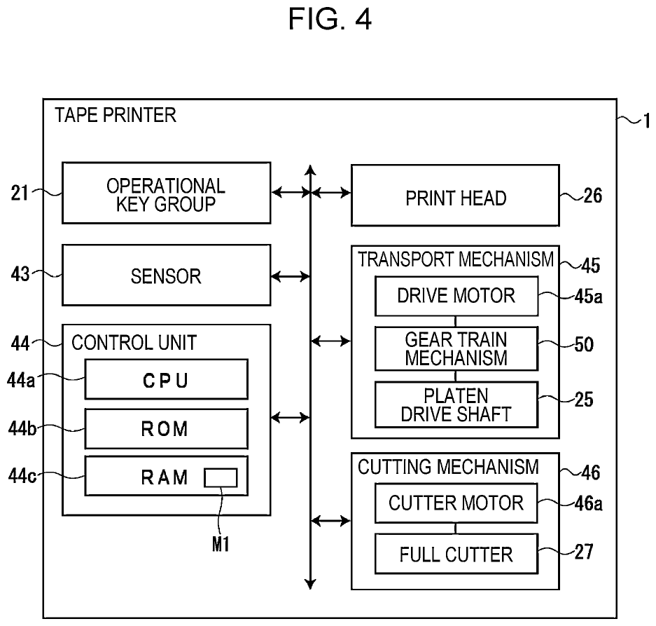

When a drive motor 45a (see FIG. 4) of the tape printer 1 with the above settings in place rotates in a first rotation direction, the platen roller 17 and the take-up core 19 rotate, causing the tape T to come out of the cartridge case 11 through the tape output port 13, with the ink ribbon R being taken up on the take-up core 19. In this case, the tape T is transported in the −X direction toward the tape outlet 24. The −X direction is an example of a first feed direction. When the drive motor 45a rotates in a second rotation direction opposite to the first rotation direction, the platen roller 17 and the unreeling core 18 rotate, pulling the tape T into the cartridge case 11 and rewinding the ink ribbon R to the unreeling core 18. In this case, the tape T is transported in the +X direction. The +X direction is an example of a second feed direction.

The print head 26 generates heat responsively to the print data while the tape T is transported in the −X direction. When subjected to heat, ink on the ink ribbon R is transferred to the tape T and, as a result, an image based on the print data is printed on the tape T. The tape T having the image printed thereon is ejected from the tape outlet 24.

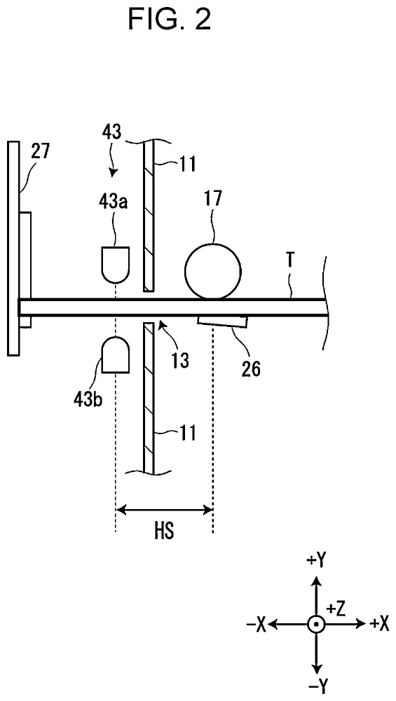

Referring to FIG. 2, a sensor 43 and a full cutter 27 are disposed between the cartridge mounting section 23 and the tape outlet 24. The sensor 43 detects the leading edge of the tape T or, more specifically, a tip on the −X side of the tape T. The leading edge of the tape T is an example of a specific position of tape. The full cutter 27 cuts the tape T along the Z-axis, that is, in the width direction of the tape T. As a result, the printed part of the tape T is cut away.

FIG. 2 illustrates the placement of the print head 26, the sensor 43, and the full cutter 27. With the tape cartridge C being mounted in the cartridge mounting section 23, the members are arranged as illustrated in FIG. 2. In this state, the platen roller 17 housed in the cartridge case 11 of the tape cartridge C and the print head 26 are located opposite each other with the tape T therebetween.

As illustrated in FIG. 2, the detection position of the sensor 43 is further in the −X direction than the printing position of the print head 26. The sensor 43 includes a light-emitting section 43a and a light-receiving section 43b, which is located opposite the light-emitting section 43a with the tape T therebetween. The distance between the detection position of sensor 43 and the printing position of the print head 26 in the X-axis direction is hereinafter referred to as a sensor-to-head distance HS.

The printing processing ends when the printed part of the tape T is cut away, in which state the leading edge of the tape T is usually located at the cutting position of the full cutter 27. In some cases, however, the tape cartridge C is not used as is usual and, as a result, the leading edge of the tape T is further in the +X direction than the detection position of the sensor 43. For example, this may happen when the user takes the tape cartridge C out of the cartridge mounting section 23 and cuts the tape T with scissors at a position close to the tape output port 13 of the cartridge case 11.

Thus, the leading edge of the tape T is not always located at the cutting position of the full cutter 27. For this reason, the tape printer 1 determines whether the leading edge of the tape T is further in the +X direction than the detection position, based on the detection results given by the sensor 43. Specifically, the tape printer 1 determines that the leading edge of the tape T is further in the +X direction than the detection position when the sensor 43 is in a light-receiving state, and the tape printer 1 determines that the leading edge of the tape T is further in the −X direction than the detection position when the sensor 43 is in a light-shielded state.

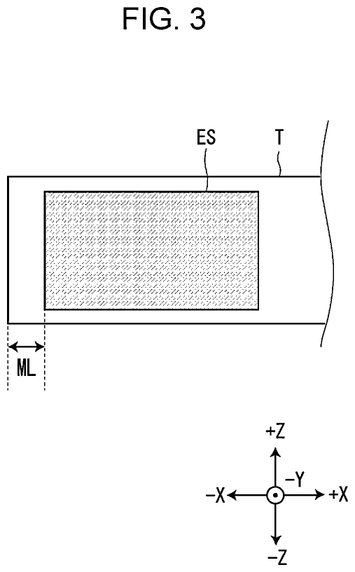

FIG. 3 illustrates an example of the tape T. The diagonally shaded area on the tape T in FIG. 3 is a print target area ES. The print target area ES is the area that is to be subjected to printing performed by the print head 26. The print target area ES is defined by a rectangle in which the print image to be printed on the tape T is enclosed.

The distance from the leading edge of the tape T to the edge on the −X side of the print target area ES is hereinafter referred to as a margin distance ML. The edge on the −X side of the print target area ES is the printing start position of the tape T.

The hardware configuration of the tape printer 1 is described below with reference to FIG. 4. The tape printer 1 includes the operational key group 21, the sensor 43, a control unit 44, the print head 26, a transport mechanism 45, and a cutting mechanism 46.

The operational key group 21 includes character keys, numeric keys, and a print key. The user can issue a command to start printing by using the print key.

As illustrated in FIG. 2, the sensor 43 is a transmissive sensor including the light-emitting section 43a and the light-receiving section 43b. The sensor 43 detects the presence or absence of the tape T at the detection position while the tape T is transported by the transport mechanism 45. The sensor 43 in the present embodiment is used to determine whether the leading edge of the tape T is further in the +X direction or the −X direction than the detection position and whether the leading edge of the tape T has passed the detection position.

The control unit 44 includes a central processing unit (CPU) 44a, read-only memory (ROM) 44b, and random-access memory (RAM) 44c. The RAM 44c includes a first storage M1, which is the location of storage of the idle feed amount calculated in calculation control described below.

The CPU 44a performs various kinds of control by executing control programs (e.g., firmware) stored in the ROM 44b after loading them into the RAM 44c. An application-specific integrated circuit (ASIC) or any other hardware circuit may be used in place of the CPU 44a as the processor of the control unit 44. Alternatively, one or more CPUs may operate in cooperation with a hardware circuit, such as an ASIC, to serve as a processor.

The print head 26 includes a heating element array (not illustrated), and the tape T is printed with ink in the ink ribbon R by thermal transfer. The heating element array consists of heating elements arranged along the Z-axis.

The transport mechanism 45 includes the drive motor 45a, a gear train mechanism 50, and the platen drive shaft 25. The drive motor 45a is configured to rotate in the first rotation direction and in the second rotation direction opposite to the first rotation direction. The gear train mechanism 50 includes gears to transmit power of the drive motor 45a to the platen drive shaft 25. The platen drive shaft 25 fits in the platen roller 17 of the tape cartridge C and causes the platen roller 17 to rotate.

The drive motor 45a in the present embodiment is a stepper motor. The control unit 44 controls the feed amount of the tape T based on the number of drive steps of rotation of the drive motor 45a.

The gear train mechanism 50 transmits power of the drive motor 45a to the platen drive shaft 25 to cause the platen roller 17 to transport the tape T in the −X direction during rotation of the drive motor 45a in the first rotation direction and to cause the platen roller 17 to transport the tape T in the +X direction during rotation of the drive motor 45a in the second rotation direction.

The cutting mechanism 46 includes a cutter motor 46a and the full cutter 27. The cutter motor 46a is a drive source that drives the full cutter 27. When the cutter motor 46a is started, the full cutter 27 goes into action and cuts the tape T along the Z-axis.

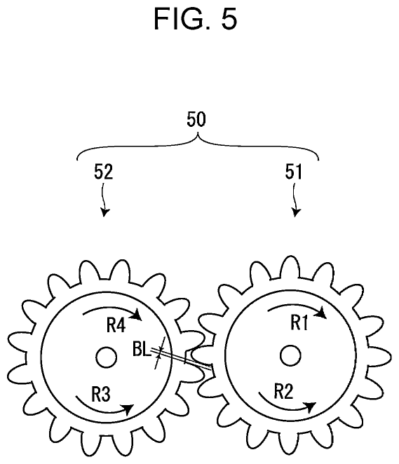

The gear train mechanism 50 is described below with reference to FIG. 5. As illustrated in FIG. 5, the gear train mechanism 50 includes a first gear 51 and a second gear 52. The first gear 51 is located on the driving side to receive power from the drive motor 45a. The second gear 52 is located on the driven side to receive power from the first gear 51.

When the drive motor 45a rotates in the first rotation direction, the first gear 51 rotates in a rotation direction R1, causing the second gear 52 to rotate in a rotation direction R3. When the drive motor 45a rotates in the second rotation direction, the first gear 51 rotates in a rotation direction R2, causing the second gear 52 to rotate in a rotation direction R4.

A small clearance is left between the tooth surface of the first gear 51 and the tooth surface of the second gear 52. The clearance is referred to as a backlash and is herein denoted by BL. The backlash BL is a play between the tooth surfaces of the gears. Each pair of gears in mesh can rotate smoothly due to the presence of the backlash BL. Since the backlash BL is present between the tooth surfaces of the gears, the actual feed amount of the tape T at the time of the reversal of rotation of the drive motor 45a deviates from the feed amount of the tape T estimated at design time based on the number of drive steps of rotation of the drive motor 45a. In addition, the feed amount deviation may vary from product to product regarding the tape printer 1. The variations in the feed amount deviation may also be due to unit-to-unit variations of the tape cartridge C. The reason for this is that there are unit-to-unit variations of the tape cartridge C in the amount of clearance in the direction of rotation of the platen roller 17 in the part where the platen drive shaft 25 fits into the platen roller 17 of the tape cartridge C mounted in the cartridge mounting section 23.

Thus, the accuracy with which the tape T is fed may decrease due to the backlash BL in the gear train mechanism 50. To address such a problem, the tape printer 1 according to the present embodiment drives the drive motor 45a to the extent that the backlash BL in the gear train mechanism 50 is compensated in response to the reversal of rotation of the drive motor 45a before the tape printer 1 drives the drive motor 45a to the extent that the tape T is advanced by the tape feed amount. There is a lag between the time when the direction of rotation of the drive motor 45a is reversed and the time when the platen roller 17 starts rotating. The amount by which the drive motor 45a rotates during the time lag is herein referred to as the idle feed amount. The idle feed amount is not stored in advance in the tape printer 1 according to the present embodiment. Instead, the tape printer 1 according to the present embodiment determines the idle feed amount by calculation in which the drive motor 45a is actually driven to transport the tape T.

As described above, the tape printer 1 calculates

the idle feed amount based on the measurement in which the drive motor 45a is actually driven to feed the tape T in consideration of the product-to-product variations of the tape printer 1 and the unit-to-unit variations of the tape cartridge C. The tape printer 1 can therefore more reliably eliminate or reduce the possibility that the accuracy with which the tape T is fed decreases due to the backlash BL in the gear train mechanism 50. As a result, the tape printer 1 eliminates or reduces the possibility that an error in the margin distance ML of the tape T will arise from misalignment between the printing start position of the tape T and the printing position of the print head 26.

The following control is performed to eliminate or reduce the possibility that the accuracy with which the tape T is fed decreases. Although two gears constituting an example of the gear train mechanism 50 are illustrated in FIG. 5, the gear train mechanism 50 may include three or more gears.

The following describes the functions of the control unit 44 illustrated in FIG. 4. The control unit 44 calculates the idle feed amount by performing measurement control and calculation control as described below. When the leading edge of the tape T is further in the −X direction than the detection position of the sensor 43 before the start of the feeding of the tape T, the measurement control is performed as follows. The control unit 44 rotates the drive motor 45a in the second rotation direction to make the leading edge of the tape T be in the detection position. With the leading edge of the tape T being in the detection position of the sensor 43, the control unit 44 rotates the drive motor 45a in the second rotation direction by a first rotation amount and then rotates the drive motor 45a in the first rotation direction. The control unit 44 then measures a detected rotation amount that is the amount of rotation of the drive motor 45a from when the drive motor 45a starts rotating in the first rotation direction to when the passage of the leading edge of the tape T through the detection position is detected. The state in which the leading edge of the tape T is further in the −X direction than the detection position of the sensor 43 may be the state in which the tape T has been detected at the detection position by the sensor 43.

When the leading edge of the tape T is further in the +X direction than the detection position of the sensor 43 before the start of the feeding of the tape T, the measurement control is performed as follows. The control unit 44 rotates the drive motor 45a in the first rotation direction to make the leading edge of the tape T be in the detection position. With the leading edge of the tape T being in the detection position of the sensor 43, the control unit 44 rotates the drive motor 45a in the first rotation direction by the first rotation amount and then rotates the drive motor 45a in the second rotation direction. The control unit 44 then measures a detected rotation amount that is the amount of rotation of the drive motor 45a from when the drive motor 45a starts rotating in the second rotation direction to when the passage of the leading edge of the tape T through the detection position is detected. The state in which the leading edge of the tape T is further in the +X direction than the detection position of the sensor 43 may be the state in which the tape T has not been detected yet at the detection position by the sensor 43.

Upon completion of the measurement control, the control unit 44 performs the calculation control. The calculation control is performed in the following manner: the control unit 44 calculates the idle feed amount based on both the detection rotation amount measured in the measurement control and the first rotation amount. More specifically, the control unit 44 calculates the idle feed amount by subtracting the first rotation amount from the detected rotation amount. The detected rotation amount and the first rotation amount each refer to the number of drive steps of rotation of the drive motor 45a.

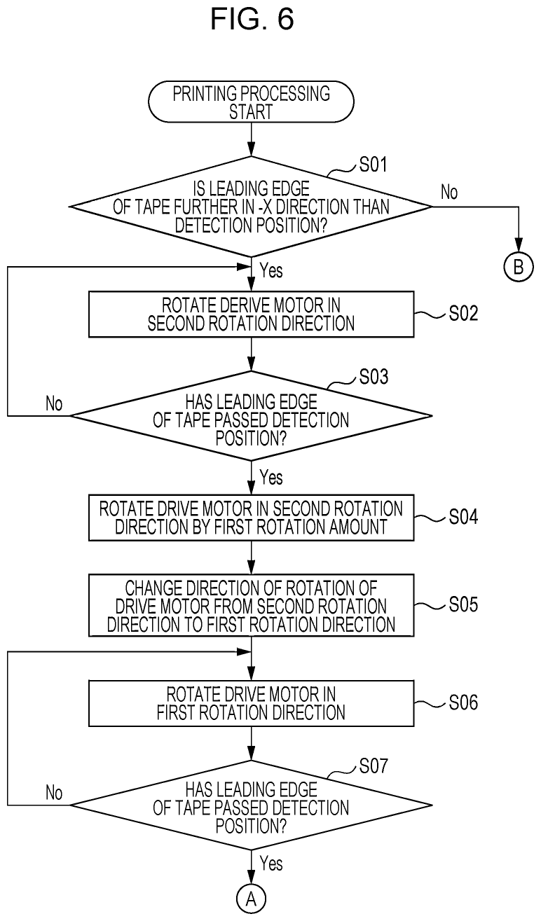

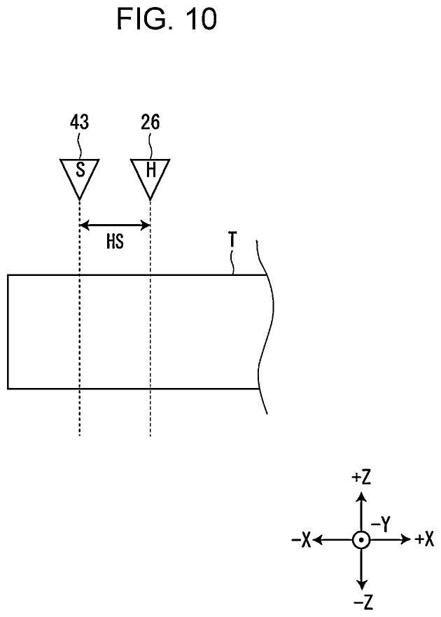

The procedure of printing processing executed by the tape printer 1 is described below with reference to a flowchart in FIGS. 6 to 9 and explanatory diagrams in FIGS. 10 to 16, in which the position of the tape is illustrated. The printing processing executed by the tape printer 1 is an example of a control method for a tape printer. The tape printer 1 starts executing the printing processing upon receipt of a command for starting a print job. The tape printer 1 receives a command for starting a print job when the user enters the command by using the print key included in the operational key group 21. Upon receipt of the command for starting a print job, the tape printer 1 produces print data based on results of the print image editing performed by the user. The printing processing described below is executed based on the print data.

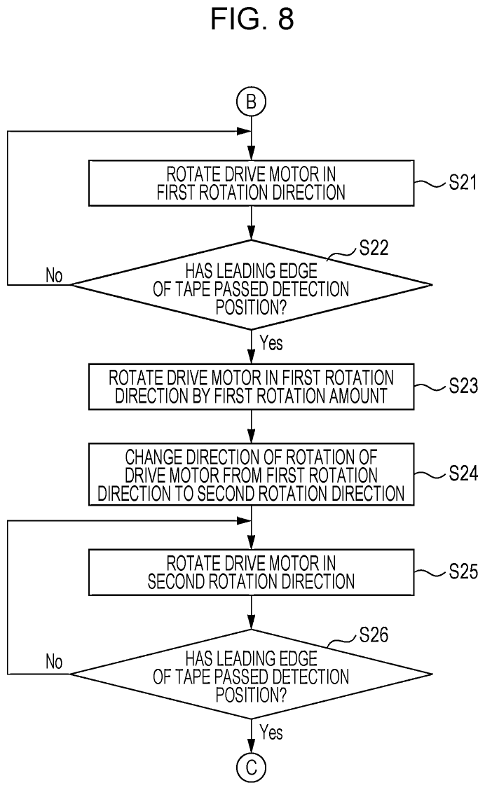

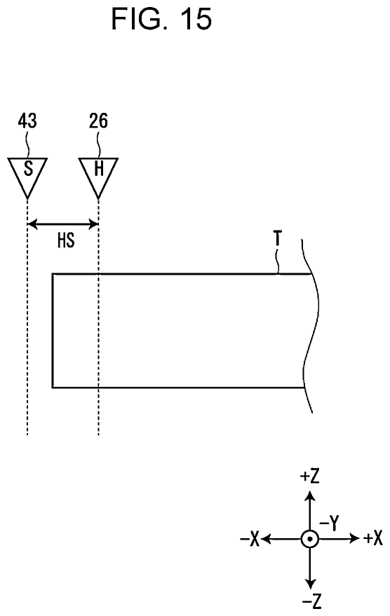

In Step S01 (see FIG. 6), the tape printer 1 determines whether the leading edge of the tape T is further in the −X direction than the detection position. The tape printer 1 determines that the leading edge of the tape T is further in the −X direction than the detection position when the sensor 43 is in the light-shielded state, and the tape printer 1 determines that the leading edge of the tape T is further in the +X direction than the detection position when the sensor 43 is in the light-receiving state. FIG. 10 illustrates the state in which the leading edge of the tape T is further in the −X direction than the detection position. FIG. 15 illustrates the state in which the leading edge of the tape T is further in the +X direction than the detection position. When determining that the leading edge of the tape T is further in the −X direction than the detection position, the tape printer 1 proceeds to Step S02. When determining that the leading edge of the tape T is further in the +X direction than the detection position, the tape printer 1 proceeds to Step S21 (see FIG. 8).

In Step S02, the tape printer 1 rotates the drive motor 45a in the second rotation direction. As a result, the tape T is transported in the +X direction.

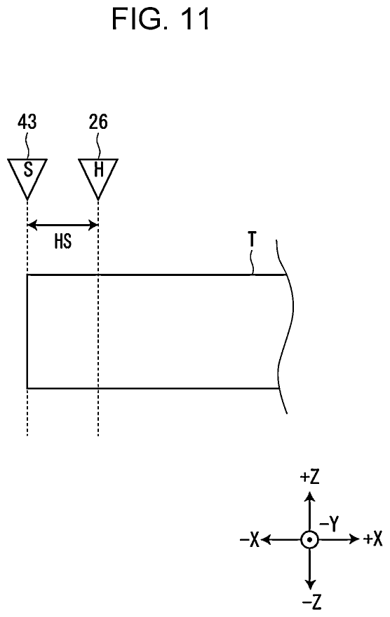

In Step S03, the tape printer 1 determines whether the leading edge of the tape T has passed the detection position. When the sensor 43 makes a transition from the light-shielded state to the light-receiving state, the tape printer 1 determines that the leading edge of the tape T has passed the detection position. FIG. 11 illustrates the state in which the leading edge of the tape T is past the detection position. When determining that the leading edge of the tape T has passed the detection position, the tape printer 1 proceeds to Step S04. When determining that the leading edge of the tape T has not passed the detection position yet, the tape printer 1 returns to Step S02.

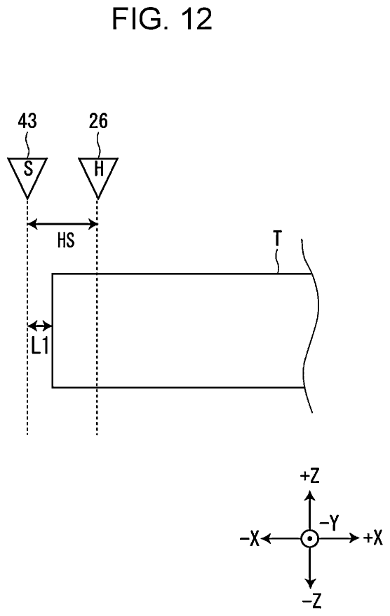

In Step S04, the tape printer 1 rotates the drive motor 45a in the second rotation direction by the first rotation amount. FIG. 12 illustrates the state in which the drive motor 45a is rotated in the second rotation direction by the first rotation amount after it is determined in Step S03 that the leading edge of the tape T has passed the detection position. As illustrated in FIG. 12, the tape T is transported in the +X direction by a first distance L1 when the drive motor 45a is rotated in the second rotation direction by the first rotation amount.

In Step S05, the tape printer 1 changes the direction of rotation of the drive motor 45a from the second rotation direction to the first rotation direction.

In Step S06, the tape printer 1 rotates the drive motor 45a in the first rotation direction. As a result, the tape T is transported in the −X direction.

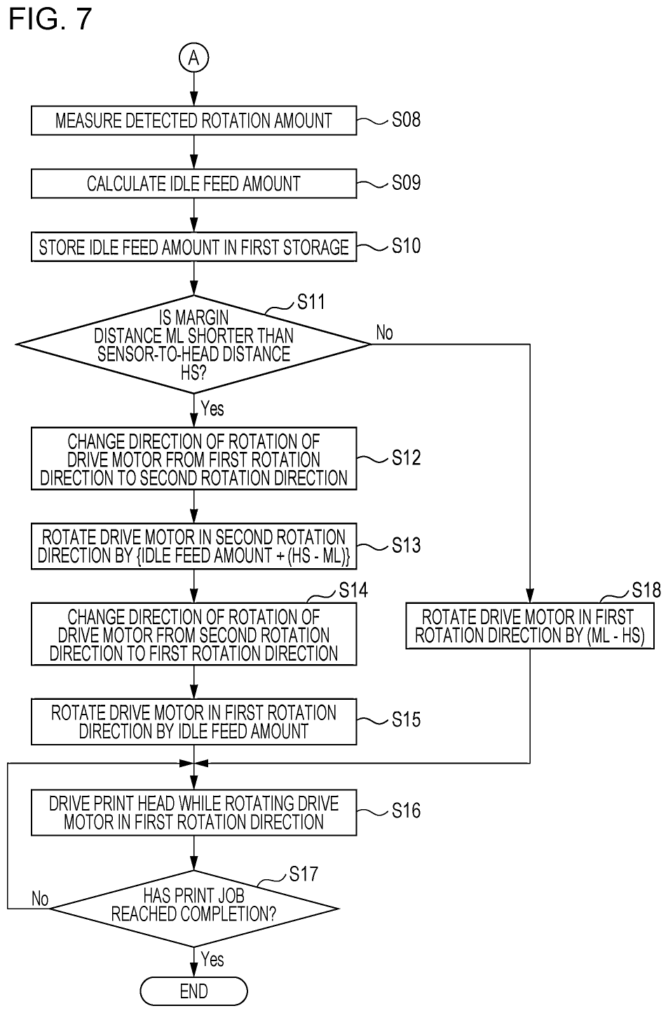

In Step S07, the tape printer 1 determines whether the leading edge of the tape T has passed the detection position. When the sensor 43 makes a transition from the light-receiving state to the light-shielded state, the tape printer 1 determines that the leading edge of the tape T has passed the detection position. When determining that the leading edge of the tape T has passed the detection position, the tape printer 1 proceeds to Step S08 (see FIG. 7). When determining that the leading edge of the tape T has not passed the detection position yet, the tape printer 1 returns to Step S06.

In Step S08 (see FIG. 7), the tape printer 1 measures the detected rotation amount. The tape printer 1 measures the detected rotation amount that is the amount of rotation of the drive motor 45a from when the drive motor 45a starts rotating in the first rotation direction in Step S06 to when it is determined in Step S07 that the specific position of the tape T has passed the detection position. Steps S04 to S08 constitute an example of the measurement control.

In Step S09, the tape printer 1 calculates the idle feed amount. The tape printer 1 calculates the idle feed amount by subtracting the first rotation amount from the detected rotation amount measured in Step S08. Step S09 is an example of the calculation control.

In Step S10, the tape printer 1 stores the idle rotation amount in the first storage M1.

In Step S11, the tape printer 1 determines whether the margin distance ML is shorter than the sensor-to-head distance HS. When determining that the margin distance ML is shorter than the sensor-to-head distance HS, the tape printer 1 proceeds to Step S12. When determining that the margin distance ML is longer than or equal to the sensor-to-head distance HS, the tape printer 1 proceeds to Step S18.

In Step S12, the tape printer 1 changes the direction of rotation of the drive motor 45a from the first rotation direction to the second rotation direction.

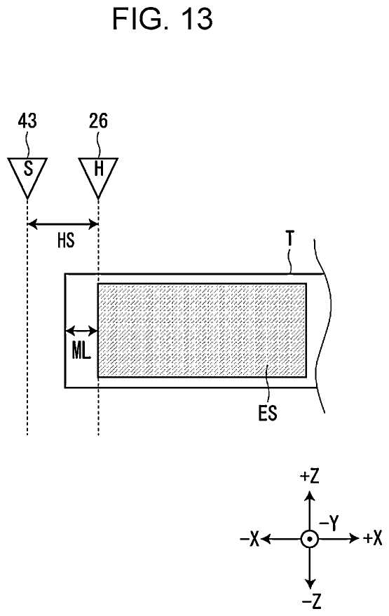

In Step S13, the tape printer 1 rotates the drive motor 45a in the second rotation direction by {idle feed amount+(HS−ML)}. In this step, the tape printer 1 searches through the first storage M1 and retrieves the idle feed amount from the first storage M1. The distance obtained by subtracting the margin distance ML from the sensor-to-head distance HS is mathematically expressed as (HS−ML). With the leading edge of the tape T being in the detection position, Step S13 is performed and, as a result, the tape T is transported in the +X direction by the distance obtained by subtracting the margin distance ML from the sensor-to-head distance HS. FIG. 13 illustrates the state after the tape T is transported in Step S13. When the margin distance ML is shorter than the sensor-to-head distance HS, the tape printer 1 places the tape T in the printing start position in the following manner: with the leading edge of the tape T being in the detection position, the tape T is transported in the +X direction by the distance obtained by subtracting the margin distance ML from the sensor-to-head distance HS.

In Step S14, the tape printer 1 changes the direction of rotation of the drive motor 45a from the second rotation direction to the first rotation direction.

In Step S15, the tape printer 1 rotates the drive motor 45a in the first rotation direction by the idle feed amount. In this step, the tape printer 1 searches through the first storage M1 and retrieves the idle feed amount from the first storage M1. The drive motor 45a is then rotated by the retrieved first feed amount. At this stage, the platen roller 17 does not rotate.

In Step S16, the tape printer 1 drives the print head 26 while rotating the drive motor 45a in the first rotation direction. This enables the tape printer 1 to print on the tape T.

In Step S17, the tape printer 1 determines whether the print job has reached completion. The state in which a print job has reached completion may be the state in which the control based on the print data is ended. When determining that the print job has reached completion, the tape printer 1 ends the printing processing. When determining that the print job has not reached completion yet, the tape printer 1 returns to Step S16.

Upon completion of the print job, the tape printer 1 may erase the idle feed amount from the first storage M1. Alternatively, the tape printer 1 may store the latest idle feed amount in the first storage M1 by updating the idle feed amount that is currently stored in the first storage M1. The same holds true for Step S35, which will be described later.

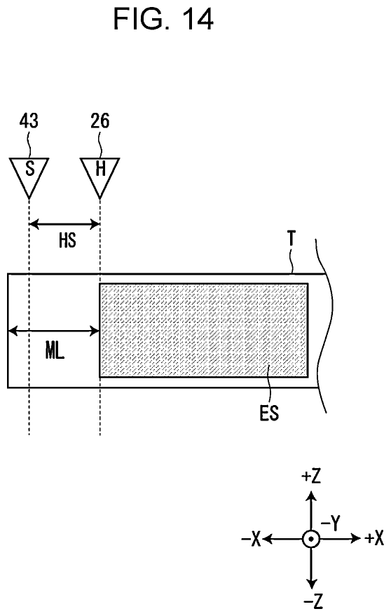

In Step S18, the tape printer 1 rotates the drive motor 45a in the first rotation direction by the amount obtained by subtracting the sensor-to-head distance HS from the margin distance ML. With the leading edge of the tape T being in the detection position, this step is performed and, as a result, the tape T is transported in the −X direction by the distance obtained by subtracting the sensor-to-head distance HS from the margin distance ML. FIG. 14 illustrates the state after the tape T is transported in Step S18. When the margin distance ML is longer than the sensor-to-head distance HS, the tape printer 1 places the tape T in the printing start position in the following manner: with the leading edge of the tape T being in the detection position, the tape T is transported in the −X direction by the distance obtained by subtracting the sensor-to-head distance HS from the margin distance ML. When the tape printer 1 determines that the margin distance ML is equal to the sensor-to-head distance HS, that is, when the distance obtained by subtracting the sensor-to-head distance HS from the margin distance ML is zero, the tape T is considered to be placed in the printing start position without actually been transported. Upon completion of Step S18, the tape printer 1 proceeds to Step S16.

In Step S21 (see FIG. 8), the tape printer 1 rotates the drive motor 45a in the first rotation direction. As a result, the tape T is transported in the −X direction.

In Step S22, the tape printer 1 determines whether the leading edge of the tape T has passed the detection position. When the sensor 43 makes a transition from the light-receiving state to the light-shielded state, the tape printer 1 determines that the leading edge of the tape T has passed the detection position. When determining that the leading edge of the tape T has passed the detection position, the tape printer 1 proceeds to Step S23. When determining that the leading edge of the tape T has not passed the detection position yet, the tape printer 1 returns to Step S21.

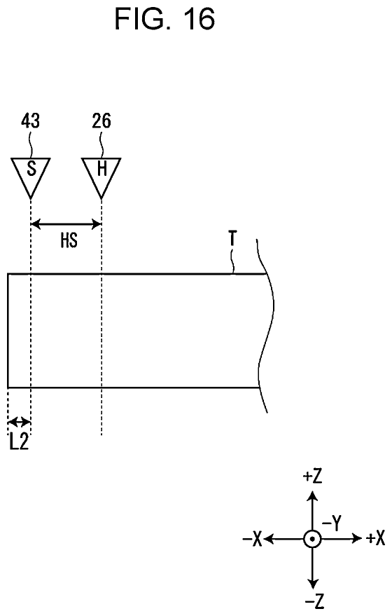

In Step S23, the tape printer 1 rotates the drive motor 45a in the first rotation direction by the first rotation amount. FIG. 16 illustrates the state in which the drive motor 45a is rotated in the first rotation direction by the first rotation amount after it is determined in Step S22 that the leading edge of the tape T has passed the detection position. As illustrated in FIG. 16, the tape T is transported in the −X direction by a second distance L2 when the drive motor 45a is rotated in the first rotation direction by the first rotation amount.

In Step S24, the tape printer 1 changes the direction of rotation of the drive motor 45a from the first rotation direction to the second rotation direction.

In Step S25, the tape printer 1 rotates the drive motor 45a in the second rotation direction. As a result, the tape T is transported in the +X direction.

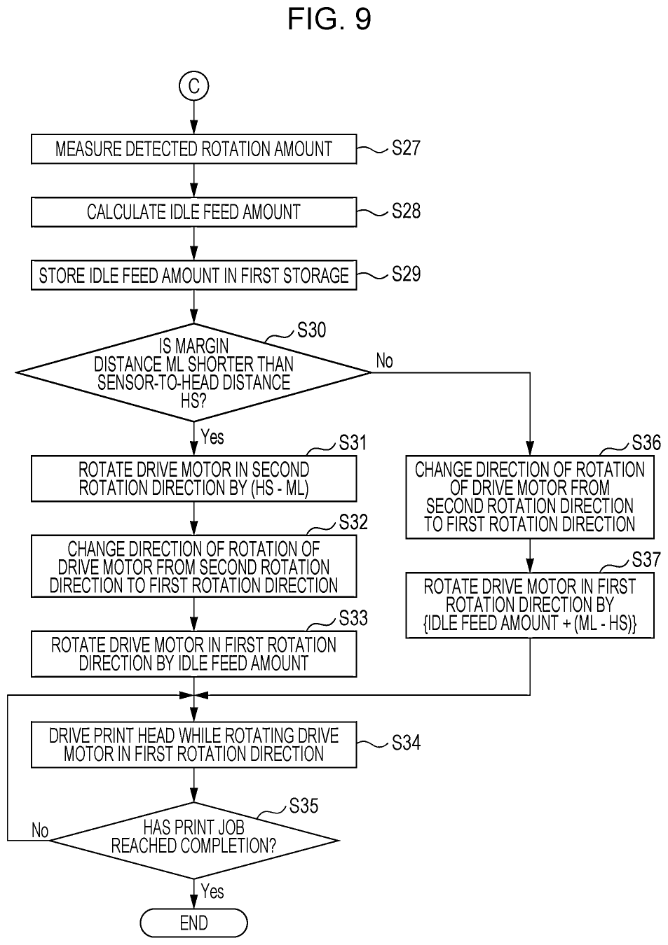

In Step S26, the tape printer 1 determines whether the leading edge of the tape T has passed the detection position. When the sensor 43 makes a transition from the light-shielded state to the light-receiving state, the tape printer 1 determines that the leading edge of the tape T has passed the detection position. When determining that the leading edge of the tape T has passed the detection position, the tape printer 1 proceeds to Step S27 (see FIG. 9). When determining that the leading edge of the tape T has not passed the detection position yet, the tape printer 1 returns to Step S25.

In Step S27 (see FIG. 9), the tape printer 1 measures the detected rotation amount. The tape printer 1 measures the detected rotation amount that is the amount of rotation of the drive motor 45a from when the drive motor 45a starts rotating in the second rotation direction in Step S25 to when it is determined in Step S26 that the specific position of the tape T has passed the detection position. Steps S23 to S27 constitute an example of the measurement control.

In Step S28, the tape printer 1 calculates the idle feed amount. The tape printer 1 calculates the idle feed amount by subtracting the first rotation amount from the detected rotation amount measured in Step S27. Step S28 is an example of the calculation control.

In Step S29, the tape printer 1 stores the idle rotation amount in the first storage M1.

In Step S30, the tape printer 1 determines whether the margin distance ML is shorter than the sensor-to-head distance HS. When determining that the margin distance ML is shorter than the sensor-to-head distance HS, the tape printer 1 proceeds to Step S31. When determining that the margin distance ML is longer than or equal to the sensor-to-head distance HS, the tape printer 1 proceeds to Step S36.

In Step S31, the tape printer 1 rotates the drive motor 45a in the second rotation direction by the amount obtained by subtracting the margin distance ML from the sensor-to-head distance HS. With the leading edge of the tape T being in the detection position, this step is performed and, as a result, the tape T is transported in the +X direction by the distance obtained by subtracting the margin distance ML from the sensor-to-head distance HS. FIG. 13 illustrates the state after the tape T is transported in Step S31. As mentioned above, when the margin distance ML is shorter than the sensor-to-head distance HS, the tape printer 1 places the tape T in the printing start position in the following manner: with the leading edge of the tape T being in the detection position, the tape T is transported in the +X direction by the distance obtained by subtracting the margin distance ML from the sensor-to-head distance HS.

In Step S32, the tape printer 1 changes the direction of the drive motor 45a from the second rotation direction to the first rotation direction.

In Step S33, the tape printer 1 rotates the drive motor 45a in the first rotation direction by the idle feed amount. In this step, the tape printer 1 searches through the first storage M1 and retrieves the idle feed amount from the first storage M1. The drive motor 45a is then rotated by the retrieved first feed amount. At this stage, the platen roller 17 does not rotate.

In Step S34, the tape printer 1 drives the print head 26 while rotating the drive motor 45a in the first rotation direction. This enables the tape printer 1 to print on the tape T.

In Step S35, the tape printer 1 determines whether the print job has reached completion. When determining that the print job has reached completion, the tape printer 1 ends the printing processing. When determining that the print job has not reached completion yet, the tape printer 1 returns to Step S34.

In Step S36, the tape printer 1 changes the direction of rotation of the drive motor 45a from the second rotation direction to the first rotation direction.

In Step S37, the tape printer 1 rotates the drive motor 45a in the first rotation direction by {idle feed amount+(ML−HS)}. In this step, the tape printer 1 searches through the first storage M1 and retrieves the idle feed amount from the first storage M1. The distance obtained by subtracting the sensor-to-head distance HS from the margin distance ML is mathematically expressed as (ML−HS). With the leading edge of the tape T being in the detection position, Step S37 is performed and, as a result, the tape T is transported in the −X direction by the distance obtained by subtracting the margin distance ML from the sensor-to-head distance HS. FIG. 14 illustrates the state after the tape T is transported in Step S37. As mentioned above, when the margin distance ML is longer than the sensor-to-head distance HS, the tape printer 1 places the tape T in the printing start position in the following manner: with the leading edge of the tape T being in the detection position, the tape T is transported in the −X direction by the distance obtained by subtracting the sensor-to-head distance HS from the margin distance ML. When the tape printer 1 determines that the margin distance ML is equal to the sensor-to-head distance HS, that is, when the distance obtained by subtracting the sensor-to-head distance HS from the margin distance ML is zero, the tape T is considered to be placed in the printing start position without actually been transported. Upon completion of Step S37, the tape printer 1 proceeds to Step S34.

As mentioned above, the tape printer 1 can calculate the idle feed amount based on the detected rotation amount measured in which the drive motor 45a is actually driven to transport the tape T in consideration of the product-to-product variations of the tape printer 1. The tape printer 1 can therefore eliminate or reduce the possibility that the accuracy with which the tape T is fed decreases due to the action of the gear train mechanism 50 or unit-to-unit variations of the tape cartridge C. As a result, the tape printer 1 eliminates or reduces the possibility that an error in the margin distance ML of the tape T will arise from misalignment between the printing start position of the tape T and the printing position of the print head 26.

The tape printer 1 can calculate the idle feed amount with simple arithmetic or, more specifically, by subtracting the first rotation amount from the detected rotation amount.

When the leading edge of the tape T is further in the −X direction than the detection position before the start of the feeding of the tape T, the tape printer 1 performs the measurement control in the following manner: the drive motor 45a is rotated in the second rotation direction until the leading edge of the tape T passes through the detection position and is further in the +X direction than the detection position, and subsequently, the drive motor 45a is rotated in the first rotation direction. When the leading edge of the tape T is further in the +X direction than the detection position before the start of the feeding of the tape T, the tape printer 1 performs the measurement control in the following manner: the drive motor 45a is rotated in the first rotation direction until the leading edge of the tape T passes through the detection position and is further in the −X direction than the detection position, and subsequently, the drive motor 45a is rotated in the second rotation direction. When performing the measurement control, the tape printer 1 changes the feed direction based on whether the leading edge of the tape T is further in the −X direction than the detection position before the start of the feeding of the tape T. This means that the direction of rotation of the drive motor 45a needs to be reversed only once for the measurement of the detected rotation amount, regardless of where the leading edge of the tape T is located before the start of the feeding of the tape T.

The following variations of the embodiment described above may be adopted.

### VARIATION 1

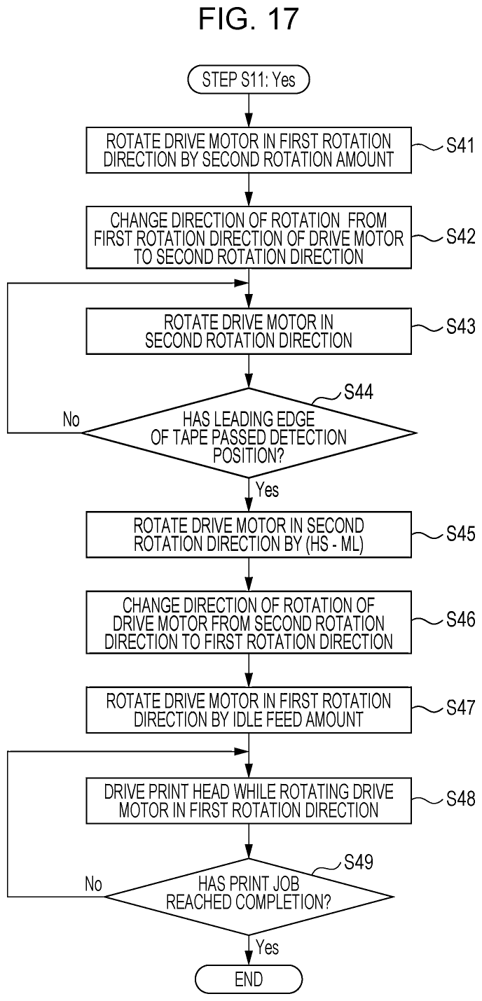

When determining that the answer in Step S11 in the flowchart (see FIG. 7) is Yes, the tape printer 1 may perform the processing illustrated in FIG. 17.

In Step S41 (see FIG. 17), the tape printer 1 rotates the drive motor 45a in the first rotation direction by a second rotation amount. The second rotation amount may be more than or less than the first rotation amount or may be equal to the first rotation amount. As a result, the leading edge of the tape T is further in the −X direction than the detection position.

In Step S42, the tape printer 1 changes the direction of rotation of the drive motor 45a from the first rotation direction to the second rotation direction.

In Step S43, the tape printer 1 rotates the drive motor 45a in the second rotation direction. As a result, the tape T is transported in the +X direction.

In Step S44, the tape printer 1 determines whether the leading edge of the tape T has passed the detection position. When the sensor 43 makes a transition from the light-shielded state to the light-receiving state, the tape printer 1 determines that the leading edge of the tape T has passed the detection position. When determining that the leading edge of the tape T has passed the detection position, the tape printer 1 proceeds to Step S45. When determining that the leading edge of the tape T has not passed the detection position yet, the tape printer 1 returns to Step S43.

In Step S45, the tape printer 1 rotates the drive motor 45a in the second rotation direction by (HS−ML). The distance obtained by subtracting the margin distance ML from the sensor-to-head distance HS is mathematically expressed as (HS−ML).

Steps S46 to S49 are identical to Steps S14 to S17 (see FIG. 7), respectively, and will not be further elaborated on here.

The tape printer 1 in this variation operates in the aforementioned manner when the leading edge of the tape T is further in the −X direction than the detection position before the start of the feeding of the tape T, with the margin distance ML being shorter than the sensor-to-head distance HS. That is, the tape printer 1 does not rotate the drive motor 45a by the idle feed amount in the period between the measurement of the detected rotation amount and the placement of the tape at the print starting position. After measuring the detected rotation amount, the tape printer 1 in this variation transports the tape T in the −X direction. Once the leading edge of the tape T is further in the −X direction than the detection position, the tape printer 1 reverses the direction of rotation of the drive motor 45a and then determines whether the leading edge of the tape T has passed the detection position. Thus, the tape printer 1 can further reduce the effects of the backlash BL in the gear train mechanism 50 at the time when the direction of rotation of the drive motor 45a is changed from the first rotation direction to the second rotation direction. Although the time it takes the tape printer 1 to complete a print job is longer in this variation than in the embodiment described above, the tape printer 1 in this variation can more reliably eliminate or reduce the possibility that the accuracy with which the tape T is fed decreases.

When the leading edge of the tape T is further in the +X direction than the detection position before the start of the feeding of the tape T, the control described above as a variation is unnecessary; that is, it is not necessary to make the leading edge of the tape T be further in the +X direction than the detection position by transporting the tape T in the +X direction after the detected rotation amount is measured. The reason for this is that it is not necessary to reverse the direction of rotation of the drive motor 45a in the period between the measurement of the detected rotation amount and the placement of the tape in the printing start position when the margin distance ML is shorter than the sensor-to-head distance HS. Meanwhile, it is necessary to reverse the direction of the rotation of the drive motor 45a in the period between the measurement of the detected rotation amount and the placement of the tape in the printing start position when the margin distance ML is longer than the sensor-to-head distance HS; nevertheless, the control concerned is unnecessary. The reason for this is that the margin distance ML of the tape T is long enough to preclude the possibility that the result of the print job will be seriously affected by the omission of this control.

As an extension of this, the tape printer 1 may perform the control in the aforementioned manner when the leading edge of the tape T is further in the +X direction than the detection position before the start of the feeding of the tape T, with the margin distance ML being longer than the sensor-to-head distance HS. In this case, however, it is required that the direction of rotation of the drive motor 45a in Steps S41 to S43 in the period between the measurement of the detected rotation amount and the placement of the tape in the printing start position be the reversal of the direction in the respective steps in the variation described above.

### VARIATION 2

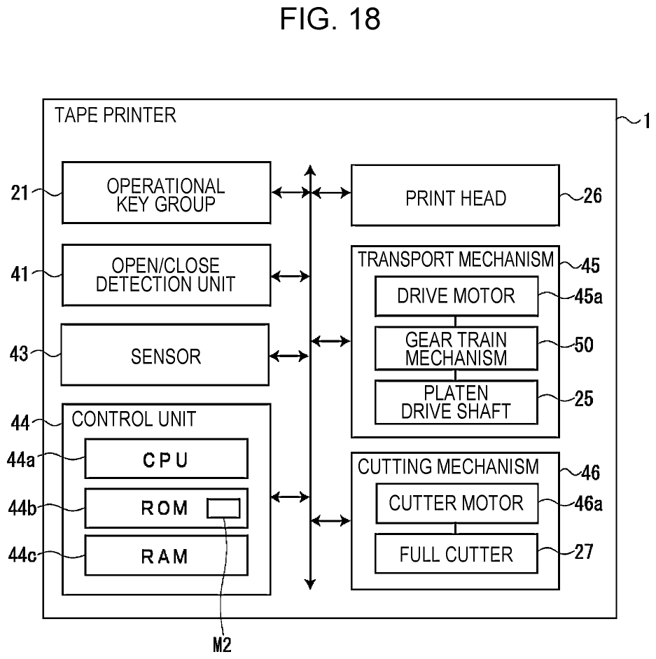

The tape printer 1 according to the embodiment described above is configured to calculate the idle feed amount every time the tape printer 1 executes the printing processing; however, this is not an absolute must. FIG. 18 is a block diagram illustrating the hardware configuration of the tape printer 1 in this variation. The tape printer 1 in this variation includes an open/close detection unit 41, which detects the opening and closing of the mounting section cover 5. The open/close detection unit 41 is an example of a mounting/demounting detection unit. The open/close detection unit 41 is a mechanical switch that detects the opening and closing of the mounting section cover 5. The tape printer 1 in this variation includes a second storage M2, which is part of the ROM 44b. The second storage M2 is an example of a storage unit. The following description will be given on the assumption that the ROM 44b in this variation is rewritable ROM.

The control unit 44 in this variation calculates the idle feed amount and then stores it in the second storage M2. When the idle feed amount is stored in the second storage M2 before the start of the feeding of the tape T, the control unit 44 starts the feeding of the tape T without performing the measurement control and the calculation control involved in the embodiment described above. When the idle feed amount is not stored in the second storage M2 before the start of the feeding of the tape T, the control unit 44 performs the measurement control and the calculation control before starting the feeding of the tape T.

When the opening of the mounting section cover 5 is detected by the open/close detection unit 41, the control unit 44 erases the idle feed amount from the second storage M2. That is, upon detection of the opening of the mounting section cover 5, the control unit 44 determines that the tape cartridge C is about to be removed, in which case the control unit 44 erases the idle feed amount from the second storage M2. The reason for erasing the idle feed amount upon detection of the opening of the mounting section cover 5 is that there are unit-to-unit variations of the tape cartridge C in the amount of clearance in the direction of rotation of the platen roller 17 in the part where the platen drive shaft 25 fits into the platen roller 17.

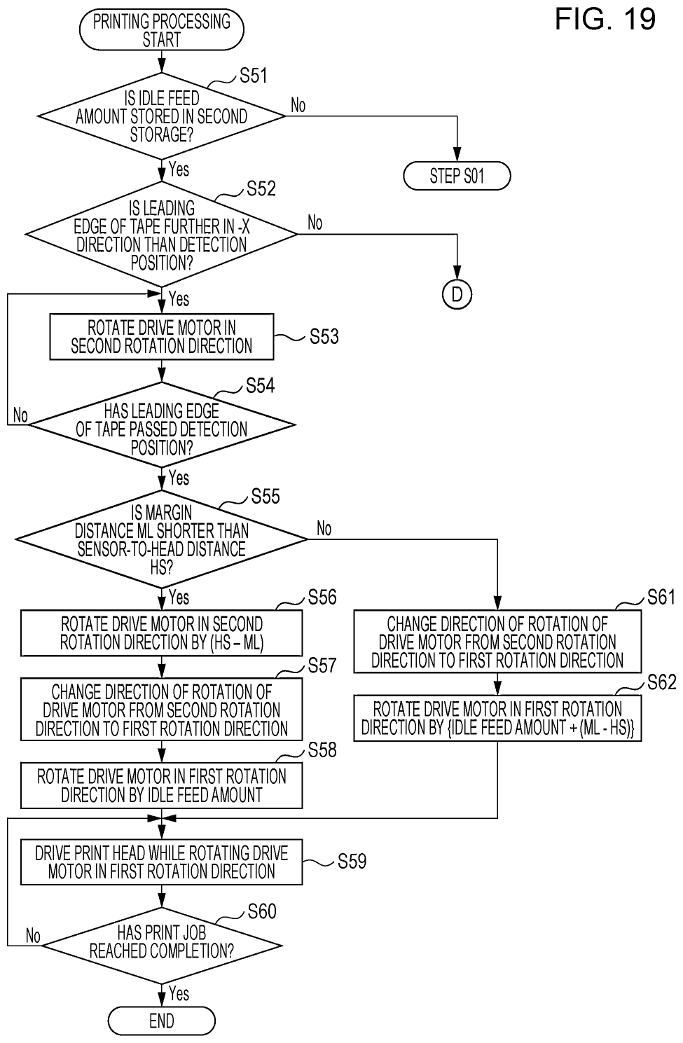

FIG. 19 is a flowchart of the printing processing in this variation. In Step S51, the tape printer 1 determines whether the idle feed amount is stored in the second storage M2. When determining that the idle feed amount is stored in the second storage M2, the tape printer 1 proceeds to Step S52. When determining that the idle feed amount is not stored in the second storage M2, the tape printer 1 proceeds to Step S01 (see FIG. 6). In this case, the tape printer 1 calculates the idle feed amount and then stores it in the second storage M2 in each of Step S10 (see FIG. 7) and Step S29 (see FIG. 9).

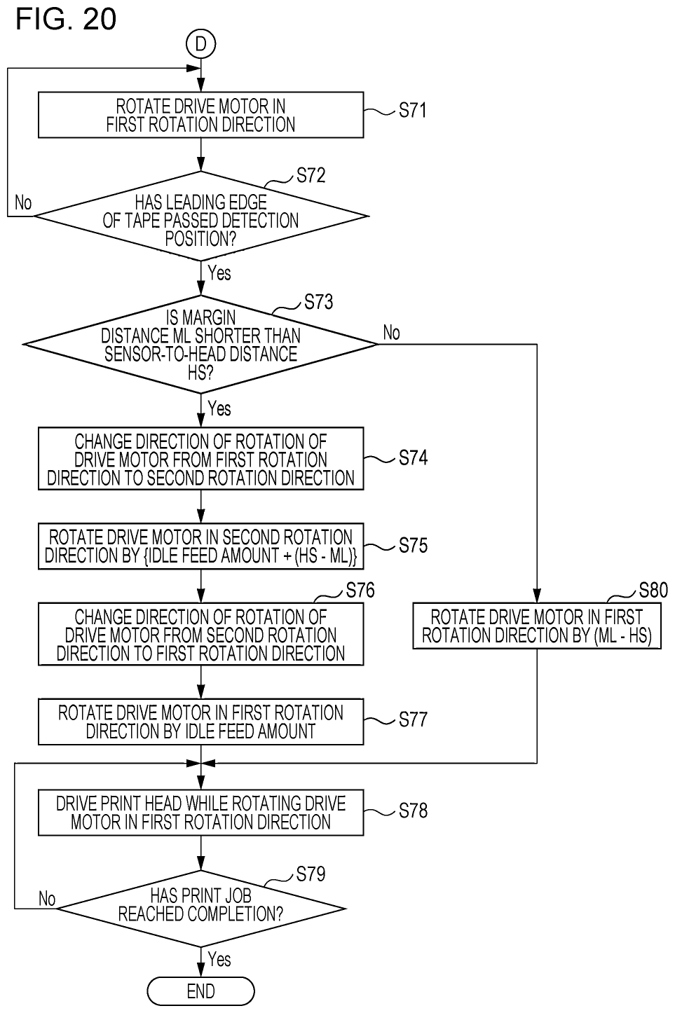

In Step S52, the tape printer 1 determines whether the leading edge of the tape T is further in the −X direction than the detection position. When determining that the leading edge of the tape T is further in the −X direction than the detection position, the tape printer 1 proceeds to Step S53. When determining that the leading edge of the tape T is further in the +X direction than the detection position, the tape printer 1 proceeds to Step S71 (see FIG. 20).

In Step S53, the tape printer 1 rotates the drive motor 45a in the second rotation direction. As a result, the tape T is transported in the +X direction.

In Step S54, the tape printer 1 determines whether the leading edge of the tape T has passed the detection position. When the sensor 43 makes a transition from the light-shielded state to the light-receiving state, the tape printer 1 determines that the leading edge of the tape T has passed the detection position. When determining that the leading edge of the tape T has passed the detection position, the tape printer 1 proceeds to Step S55. When determining that the leading edge of the tape T has not passed the detection position yet, the tape printer 1 returns to Step S53.

Steps S55 to S62 are identical to Steps S30 to S37 (see FIG. 9), respectively, and will not be further elaborated on here. However, it should be noted that the tape printer 1 retrieves the idle feed amount from the second storage M2 in Steps S58 and S62.

In Step S71 (see FIG. 20), the tape printer 1 rotates the drive motor 45a in the first rotation direction. As a result, the tape T is transported in the −X direction.

In Step S72, the tape printer 1 determines whether the leading edge of the tape T has passed the detection position. When the sensor 43 makes a transition from the light-receiving state to the light-shielded state, the tape printer 1 determines that the leading edge of the tape T has passed the detection position. When determining that the leading edge of the tape T has passed the detection position, the tape printer 1 proceeds to Step S73. When determining that the leading edge of the tape T has not passed the detection position yet, the tape printer 1 returns to Step S71.

Steps S73 to S80 are identical to Steps S11 to S18 (see FIG. 7), respectively, and will not be further elaborated on here. However, it should be noted that the tape printer 1 retrieves the idle feed amount from the second storage M2 in Steps S75 and S77.

As described above, the tape printer 1 in this variation does not need to perform the measurement control and the calculation control when the idle feed amount is stored in the second storage M2 before the start of the feeding of the tape T. This translates into the shortening of the time required to complete a print job.

There are unit-to-unit variations of the tape cartridge C in the amount of clearance in the direction of rotation of the platen roller 17 in the part where the platen drive shaft 25 fits into the platen roller 17. The unit-to-unit variations of the tape cartridge C mounted in the tape printer 1 in this variation can be reflected in the calculation of the idle feed amount, owing to the fact that the control unit 44 erases the idle feed amount from the second storage M2 when the opening of the mounting section cover 5 is detected by the open/close detection unit 41.

As an extension of this, the tape printer 1 in this variation may erase the idle feed amount from the second storage M2 when the closing of the mounting section cover 5, not the opening of the mounting section cover 5, is detected by the open/close detection unit 41.

In place of the open/close detection unit 41, a mounting detection unit that detects the presence or absence of the tape cartridge C in the cartridge mounting section 23 may be included in the tape printer 1. The mounting detection unit in this variation is another example of the mounting/demounting detection unit. For example, the mounting detection unit is a mechanical switch on the bottom face of the cartridge mounting section 23. The tape printer 1 may erase the idle feed amount from the second storage M2 when the mounting detection unit detects the mounting of the tape cartridge C in the cartridge mounting section 23 or the demounting of the tape cartridge C from the cartridge mounting section 23.

In place of the open/close detection unit 41, a tape type detection unit that identifies the type of the tape cartridge C may be included in the tape printer 1. The tape type detection unit in this variation is still another example of the mounting/demounting detection unit. An example of the tape type detection unit optically reads a code image on the outer surface of the tape cartridge C. Another example of the tape type detection unit reads tape type information from a circuit board or a radio-frequency identification (RFID) tag attached to the tape cartridge C and including a memory element. When the tape type identified by the tape type detection unit is different from the previously identified tape type, the tape printer 1 erases the idle feed amount from the second storage M2.

The tape printer 1 may erase the idle feed amount from the second storage M2 in accordance with instructions given by the user, not upon detection of the mounting or demounting of the tape cartridge C.

### VARIATION 3

When determining in Step S01 (see FIG. 6) that the leading edge of the tape T is further in the +X direction than the detection position before the start of the feeding of the tape T, the tape printer 1 may then determine whether the margin distance ML is shorter than the sensor-to-head distance HS. When determining that the margin distance ML is longer than the sensor-to-head distance HS, the tape printer 1 may skip the measurement control and the calculation control. In this case, the answer in Step S73 subsequent to Steps S71 and S72 (see FIG. 20) is No. Thus, the tape printer 1 proceeds to Step S80 and then to Steps S78 and S79.

### VARIATION 4

When determining in Step S30 (see FIG. 9) that the margin distance ML is longer than the sensor-to-head distance HS, the tape printer 1 may rotate the drive motor 45a in the first rotation direction by (ML−HS) in Step S37. That is, the tape printer 1 may skip the process of rotating the drive motor 45a by the idle feed amount in Step S37. The reason for this is that this change does not seriously affect the result of the print job when the margin distance ML is long.

### VARIATION 5

Instead of a transmissive sensor, a reflective sensor may be used as the sensor 43.

### VARIATION 6

The printing medium for use with the tape printer 1 may be die-cut label tape. Die-cut label tape consists of labels arranged on backing tape at regular intervals in the X-axis direction. In this case, the position that is to be detected by the tape printer 1 as the specific position of tape may be a detection target between the individual labels. For example, the detection target is a detection hole or a predetermined mark.

It is not required that the detection target be located between the individual labels of the die-cut label tape. For example, the detection target may be a recess or projection provided for each label and located at an end on the +Z side or −Z side of the backing tape.

### VARIATION 7

Instead of subtracting the first rotation amount from the detection rotation amount, the tape printer 1 may use a predetermined arithmetic expression to calculate the idle feed amount. The predetermined arithmetic expression contains a variable representing the value obtained by subtracting the first rotation amount from the detected rotation amount.

### VARIATION 8

The firmware for use in the tape printer 1 may be a program available to customers. Alternatively, the firmware for use in the tape printer 1 may be stored in a storage medium available to customers. It is not required that the tape printer 1 be a thermal transfer printer. For example, the tape printer 1 may be an ink jet printer. It is not required that the tape printer 1 be designed for use with the tape cartridge C mounted therein. For example, the tape printer 1 may be equipped with a platen roller, and the tape T that is to be subjected to printing may be fed from the outside the tape printer 1. It is not required that the drive motor 45a be a stepper motor. For example, the drive motor 45a may be a DC motor. In this case, the detected rotation amount and the first rotation amount may, for example, refer to the number of pulses of an encoder on the DC motor. The details described above may be changed as appropriate within a range not departing from the gist of the present disclosure.

### APPENDIX

A tape printer and a control method for a tape printer are described below. A tape printer 1 includes a drive motor 45a, a gear train mechanism 50, a sensor 43, and a control unit 44. The drive motor 45a rotates in a first rotation direction and in a second rotation direction opposite to the first rotation direction. The gear train mechanism 50 transmits power of the drive motor 45a to a platen roller 17 for feeding tape T. The sensor 43 detects a specific position of the tape T. The control unit 44 is configured to perform measurement control and calculation control. The measurement control is control in which, with the specific position of the tape T being in a detection position of the sensor 43, the control unit 44 is configured to cause the drive motor 45a to rotate in one direction of the first rotation direction and the second rotation direction by a first rotation amount and then cause the drive motor 45a to rotate in a reverse direction to the one direction. The control unit 44 is configured to measure a detected rotation amount that is the amount of rotation of the drive motor 45a from when the drive motor 45a starts rotating in the reverse direction to when the passage of the specific position of the tape T through the detection position is detected. The calculation control is control in which the control unit 44 is configured to calculate an idle feed amount based on the detected rotation amount measured in the measurement control and the first rotation amount. The idle feed amount is the amount of rotation of the drive motor 45a from the reversal of rotation of the drive motor 45a until the start of rotation of the platen roller 17.

A control method for a tape printer 1 is provided. The tape printer 1 includes a drive motor 45a, a gear train mechanism 50, and a sensor 43. The drive motor 45a rotates in a first rotation direction and in a second rotation direction opposite to the first rotation direction. The gear train mechanism 50 transmits power of the drive motor 45a to a platen roller 17 for feeding tape T. The sensor 43 detects a specific position of the tape T. The control method includes measuring a detected rotation amount and calculating an idle feed amount. With the specific position of the tape T being in a detection position of the sensor 43, the tape printer 1 causes the drive motor 45a to rotate in one direction of the first rotation direction and the second rotation direction by a first rotation amount and then causes the drive motor 45a to rotate in a reverse direction to the one direction. The detected rotation amount is the amount of rotation of the drive motor 45a from when the drive motor 45a starts rotating in the reverse direction to when the passage of the specific position of the tape T through the detection position is detected. The idle feed amount is calculated based on the detected rotation amount measured in the measuring and the first rotation amount. The idle feed amount is the amount of rotation of the drive motor 45a from the reversal of rotation of the drive motor 45a until the start of rotation of the platen roller 17.

According to the above configuration, the tape printer 1 can calculate the idle feed amount based on the detected rotation mount measured when feeding the tape T in consideration of the product-to-product variations of the tape printer 1. The tape printer 1 can therefore reliably eliminate or reduce the possibility that the accuracy with which the tape T is fed decreases due to the backlash BL in the gear train mechanism 50.

In the tape printer 1 described above, the control unit 44 of the tape printer 1 is preferably configured to calculate the idle feed amount by subtracting the first rotation amount from the detected rotation amount.

According to the above configuration, the tape printer 1 can calculate the idle feed amount with simple arithmetic.

In the tape printer 1 described above, the gear train mechanism 50 of the tape printer 1 preferably transmits the power of the drive motor 45a to the platen roller 17 to cause the platen roller 17 to transport the tape T in a first feed direction during rotation of the drive motor 45a in the first rotation direction and to cause the platen roller 17 to transport the tape T in the +X direction opposite to the first feed direction during rotation of the drive motor 45a in the second rotation direction. When the specific position of the tape T is further in the −X direction than the detection position before the start of the feeding of the tape T, the control unit 44 of the tape printer 1 is preferably configured to cause the drive motor 45a to rotate in the second rotation direction to make the specific position be in the detection position and then to perform the measurement control in which, with the specific position being in the detection position, the control unit 44 is preferably configured to cause the drive motor 45a to rotate in the second rotation direction as the one direction and then cause the drive motor 45a to rotate in the reverse direction that is the first rotation direction.

According to the above configuration, the tape printer 1 can perform the measurement control in the following manner: when the specific position of the tape T is further in the −X direction than the detection position before the start of the feeding of the tape T, the direction of rotation of the drive motor 45a is reversed only once for the measurement of the detected rotation amount.

In the tape printer 1 described above, when the specific position of the tape T is further in the +X direction than the detection position before the start of the feeding of the tape T, the control unit 44 of the tape printer 1 is preferably configured to cause the drive motor 45a to rotate in the first rotation direction to make the specific position be in the detection position and then to perform the measurement control in which, with the specific position being in the detection position, the control unit 44 is configured to cause the drive motor 45a to rotate in the first rotation direction as the one direction and then cause the drive motor 45a to rotate in the reverse direction that is the second rotation direction.

According to the above configuration, the tape printer 1 can perform the measurement control in the following manner: as is the case when the specific position of the tape T is further in the −X direction than the detection position before the start of the feeding of the tape T, when the specific position of the tape T is further in the +X direction than the detection position before the start of the feeding of the tape T, the direction of rotation of the drive motor 45a is reversed only once for the measurement of the detected rotation amount.

In the tape printer 1 described above, the control unit 44 of the tape printer 1 is preferably configured to cause a second storage M2 to store the calculated idle feed amount. When the idle feed amount is stored in the second storage M2 before the start of the feeding of the tape T, the control unit 44 is preferably configured to start the feeding of the tape T without performing the measurement control and the calculation control. When the idle feed amount is not stored in the second storage M2 before the start of the feeding of the tape T, the control unit 44 is preferably configured to perform the measurement control and the calculation control before starting the feeding of the tape T.

According to the above configuration, the tape printer 1 does not need to perform the measurement control and the calculation control when the idle feed amount is stored in the second storage M2 before the start of the feeding of the tape T. Accordingly, the time required for a print job can be reduced.

The tape printer 1 preferably further includes a cartridge mounting section 23, a platen drive shaft 25, and an open/close detection unit 41. A tape cartridge C is removably mounted in the cartridge mounting section 23. The tape T and the platen roller 17 are housed in the tape cartridge C. The platen drive shaft 25 fits in the platen roller 17. The platen drive shaft 25 causes the platen roller 17 to rotate when the power of the drive motor 45a is transmitted through the gear train mechanism 50. The open/close detection unit 41 is configured to detect demounting of the tape cartridge C from the cartridge mounting section 23 and/or mounting of the tape cartridge C in the cartridge mounting section 23. The control unit 44 of the tape printer 1 is preferably configured to erase the stored idle feed amount from the second storage M2 when the open/close detection unit 41 detects the demounting of the tape cartridge C from the cartridge mounting section 23 or the mounting of the tape cartridge C in the cartridge mounting section 23.

There are unit-to-unit variations of the tape cartridge C in the amount of clearance in the direction of rotation of the platen roller 17 in the part where the platen drive shaft 25 fits into the platen roller 17. According to the above configuration, the tape printer 1 erases the idle feed amount stored in the second storage M2 upon detection of the demounting of the tape cartridge C from the cartridge mounting section 23 or the mounting of the tape cartridge C in the cartridge mounting section 23, the idle feed amount appropriate to the tape cartridge C in use can be calculated.

What is claimed is:

1. A tape printer comprising:
a drive motor that rotates in a first rotation direction and in a second rotation direction opposite to the first rotation direction;
a gear train mechanism that transmits power of the drive motor to a feed roller for feeding tape;
a sensor that detects a specific position of the tape; and
a control unit configured to perform
measurement control and calculation control,
the measurement control being control in which, with the specific position of the tape being in a detection position of the sensor, the control unit is configured to cause the drive motor to rotate in one direction of the first rotation direction and the second rotation direction by a first rotation amount and then cause the drive motor to rotate in a reverse direction to the one direction, and the control unit is configured to measure a detected rotation amount that is an amount of rotation of the drive motor from when the drive motor starts rotating in the reverse direction to when passage of the specific position of the tape through the detection position is detected,
the calculation control being control in which the control unit is configured to calculate an idle feed amount based on the detected rotation amount measured in the measurement control and the first rotation amount, the idle feed amount being an amount of rotation of the drive motor from reversal of rotation of the drive motor until a start of rotation of the feed roller.

2. The tape printer according to claim 1, wherein the control unit is configured to calculate the idle feed amount by subtracting the first rotation amount from the detected rotation amount.

3. The tape printer according to claim 1, wherein
the gear train mechanism transmits the power of the drive motor to the feed roller to cause the feed roller to transport the tape in a first feed direction during rotation of the drive motor in the first rotation direction and to cause the feed roller to transport the tape in a second feed direction opposite to the first feed direction during rotation of the drive motor in the second rotation direction, and
when the specific position of the tape is further in the first feed direction than the detection position before a start of feeding of the tape, the control unit is configured to cause the drive motor to rotate in the second rotation direction to make the specific position be in the detection position and then to perform the measurement control in which, with the specific position being in the detection position, the control unit is configured to cause the drive motor to rotate in the second rotation direction as the one direction and then cause the drive motor in the reverse direction that is the first rotation direction.

4. The tape printer according to claim 3, wherein
when the specific position of the tape is further in the second feed direction than the detection position before the start of feeding of the tape, the control unit is configured to cause the drive motor to rotate in the first rotation direction to make the specific position be in the detection position and then to perform the measurement control in which, with the specific position being in the detection position, the control unit is configured to cause the drive motor rotate in the first rotation direction as the one direction and then cause the drive motor to rotate in the reverse direction that is the second rotation direction.

5. The tape printer according to claim 1, wherein
the control unit is configured to cause a storage unit to store the calculated idle feed amount,
when the idle feed amount is stored in the storage unit before a start of feeding of the tape, the control unit is configured to start the feeding of the tape without performing the measurement control and the calculation control, and
when the idle feed amount is not stored in the storage unit before the start of the feeding of the tape, the control unit is configured to perform the measurement control and the calculation control before starting the feeding of the tape.

6. The tape printer according to claim 5, further comprising:
a cartridge mounting section in which a tape cartridge is removably mounted, the tape and the feed roller being housed in the tape cartridge;
a roller drive shaft that fits in the feed roller, the roller drive shaft causing the feed roller to rotate when the power of the drive motor is transmitted through the gear train mechanism; and
a mounting/demounting detection unit configured to detect demounting of the tape cartridge from the cartridge mounting section and/or mounting of the tape cartridge in the cartridge mounting section, wherein
the control unit is configured to erase the stored idle feed amount from the storage unit when the mounting/demounting detection unit detects the demounting of the tape cartridge from the cartridge mounting section or the mounting of the tape cartridge in the cartridge mounting section.

7. A control method for a tape printer including
a drive motor that rotates in a first rotation direction and in a second rotation direction opposite to the first rotation direction,
a gear train mechanism that transmits power of the drive motor to a feed roller for feeding tape, and
a sensor that detects a specific position of the tape,
the control method comprising:
measuring a detected rotation amount, with the specific position of the tape being in a detection position of the sensor, the tape printer causing the drive motor to rotate in one direction of the first rotation direction and the second rotation direction by a first rotation amount and then causing the drive motor to rotate in a reverse direction to the one direction, the detected rotation amount being an amount of rotation of the drive motor from when the drive motor starts rotating in the reverse direction to when passage of the specific position of the tape through the detection position is detected; and
calculating an idle feed amount based on the detected rotation amount measured in the measuring and the first rotation amount, the idle feed amount being an amount of rotation of the drive motor from reversal of rotation of the drive motor until a start of rotation of the feed roller.
